(19) United States
(12) Patent Application Publication
(10) Pub. No.: US 2007/0009696 A1
(43) Pub. Date: Jan. 11, 2007

(54) Surface treated tube for medical use

(75) Inventors: Takeo Nakamura, Chuo-ku (JP); Teruo Aoyama, Chuo-ku (JP); Akihiko Morikawa, Chuo-ku (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: JSR Corporation, Chuo-ku (JP)

(21) Appl. No.: 11/478,613

(22) Filed: Jul. 3, 2006

(30) Foreign Application Priority Data
Jul. 1, 2005 (JP) 2005-193659

(51) Int. Cl. F16L 11/04; B32B 13/04

(52) U.S. Cl. 428/36.91; 428/446

(57) ABSTRACT

A thermoplastic elastomer molded article having a surface treated with a silicone emulsion and/or aqueous solution of silicone containing water-soluble silicone with a silicone content of 1 to 30 wt % is provided. As the thermoplastic elastomer, a composition comprising 20 to 100 wt % of 1,2-polybutadiene having a 1,2-bond content of 70% or more and a degree of crystallinity of 5 to 50% and 0 to 80 wt % of other thermoplastic elastomers, provided that the total amount of the 1,2-polybutadiene and the other thermoplactic elastomers is 100 wt %, can be given. The molded article of the present invention can be applied to various types of tubes, sheets, and hoses as well as a tube for medical use since the surface of the article has improved sliding properties and sliding wear resistance, without impairing transparency, flexibility, lightweightness, and mechanical strength.

### BACKGROUND OF THE INVENTION

1. Field of the Invention

The present invention relates to a thermoplastic elastomer molded article such as a tube for medical use having a surface reformed with a silicone emulsion and/or silicone aqueous solution, which excels in sliding properties and sliding wear resistance without impairing properties inherent to the thermoplastic elastomer molded article such as transparency, molding processability, flexibility, and lightweight.

2. Background Art

A thermoplastic elastomer or a composition thereof such as a thermoplastic elastomer composition comprising 1,2-polybutadiene or 1,2-polybutadiene and a styrene-isoprene-styrene block copolymer is used for a molded article such as an infusion tube for medical treatment due to excellent transparency, flexibility, and properties of not adsorbing medical fluids. An infusion tube for medical treatment may be used attached to a medical fluid metering pump because of its capability of circulating a constant amount of medical fluid. However, 1,2-polybutadiene has insufficient wear resistance and the surface of the infusion tube made from this polymer is easily scratched by being rubbed with a movable portion of the pump. In addition, 1,2-polybutadiene has poor sliding properties and can be attached to an immovable portion of the pump only with difficulty. If forcibly attached, the tube is unduly elongated and the diameter of the tube decreases, thereby changing the analytical speed.

Although a surface treatment with silicone is generally applied, the method has problems such as a poor coating efficiency (workability) and a tacky surface due to high viscosity of the silicone oil. Although a solution-type (solvent dilution-type) silicone excels in coating efficiency (workability), silicone diluted with a solvent easily permeates into the inside of the molded tube. Not only may the molded tube turn white, but also the working environment is impaired by solvent dispersal. If the silicone component is previously mixed into the composition for tube molding, the resulting molded tube may be whitened.

An object of the present invention is to provide a thermoplastic elastomer molded article such as a tube for medical use, having improved sliding properties and sliding wear resistance and being produced in a good work environment, without unduly impairing general properties of the thermoplastic elastomer molded article such as transparency, flexibility, lightweightness, and mechanical strength.

### SUMMARY OF THE INVENTION

The present invention relates to a thermoplastic elastomer molded article with a surface treated with a silicone emulsion and/or aqueous solution of silicone containing water-soluble silicone with a silicone content of 1 to 30 wt %.

As the thermoplastic elastomer which forms the molded article of the present invention, an elastomer composition comprising 20 to 100 wt % of 1,2-polybutadiene having a 1,2-bond content of 70% or more and a degree of crystallinity of 5 to 50% and 0 to 80 wt % of other thermoplastic elastomers, provided that the total amount of 1,2-polybutadiene and the other thermoplactic elastomers is 100 wt %, can be given.

As the other thermoplastic elastomer which can be used together with 1,2-polybutadiene, a styrene-isoprene-styrene block copolymer is preferable.

Next, the present invention relates to a method for treating the surface of a thermoplastic elastomer molded article comprising dipping a molded article produced by contour extrusion in a silicone emulsion and/or aqueous solution of silicone containing water-soluble silicone with a silicone content of 1 to 30 wt %.

A thermoplastic elastomer molded article having a surface with improved sliding properties and sliding wear resistance and being produced in a good work environment without unduly impairing the original general properties of the thermoplastic elastomer such as transparency, flexibility, lightweightness, and mechanical strength, can be obtained, by simply treating the surface of a molded article such as a tube of a thermoplastic elastomer composition comprising 20 to 100 wt % of 1,2-polybutadiene and 0 to 80 wt % of a styrene-isoprene-styrene block copolymer, which is molded by contour extrusion, using a silicone emulsion and/or aqueous solution of silicone containing a water-soluble silicone with a silicone content of 1 to 30 wt %.

As specific examples of these thermoplastic elastomer molded articles, a tube for medical use can be given.

In addition, the present invention relates to an infusion set comprising the tube for medical use.

The present invention can also be applied to various types of tubes, sheets, and hoses as well as molded articles such as a tube for medical use.

### BRIEF DESCRIPTION OF THE DRAWINGS

FIG. 1 is a plan view of an infusion set comprising the tube for medical use (a component for medical use) made from polybutadiene of the present invention.

### DETAILED DESCRIPTION OF THE INVENTION AND PREFERRED EMBODIMENTS

<Thermoplastic Elastomer Molded Article>

There is no limitation to the thermoplastic elastomer used for the thermoplastic elastomer molded article such as a tube for medical use of the present invention. 1,2-polybutadiene alone or a composition of 1,2-polybutadiene and other thermoplastic elastomers is preferably used.

The 1,2-polybutadiene is syndiotactic 1,2-polybutadiene which has a 1,2-bond content of 70% or more, and preferably 80% or more, degree of crystallinity of 5 to 50%, and preferably 10 to 40%, and a melting point of preferably 50 to 150° C., and more preferably 60 to 140° C. The degree of crystallinity and melting point in these ranges ensures the syndiotactic 1,2-polybutadiene to possess excellently balanced mechanical strength such as tensile strength, tear strength, and the like, and flexibility.

Syndiotactic 1,2-polybutadiene with a degree of crystallinity of about 5 to 25% (hereinafter referred to from time to time as “low crystalline RB”) is suitably used as a tube main body material due to excellent flexibility. The low crystalline RB, however, exhibits poor steam sterilization resistance due to the low melting point of about 70 to 95° C. It is possible to provide the low crystalline RB with heat resistance by cross-linking the polymer by electron beam radiation as described later.

The syndiotactic 1,2-polybutadiene used in the present invention, which has a 1,2-bond content of 70% or more, can be obtained by polymerizing butadiene in the presence of a catalyst containing a cobalt compound and aluminoxane, for example. However, the method for producing the syndiotactic 1,2-polybutadiene is not limited to this one.

The syndiotactic 1,2-polybutadiene used in the present invention has 1,2-bonds in a butadiene bond unit in an amount of usually 70% or more, preferably 80% or more, and more preferably 90% or more. A 1,2-bond content of 70% or more ensures the 1,2-polybutadiene to exhibit excellent characteristics as a thermoplastic elastomer.

The syndiotactic 1,2-polybutadiene used in the present invention may contain a small amount of conjugated dienes other than butadiene copolymerized with butadiene. As the conjugated dienes other than butadiene, 1,3-pentadiene, 1,3-butadiene derivatives substituted with a higher alkyl group, 2-alkyl-substituted 1,3-butadiene, and the like can be given.

As examples of the 1,3-butadiene derivative substituted with a higher alkyl group, 1-pentyl-1,3-butadiene, 1-hexyl-1,3-butadiene, 1-heptyl-1,3-butadiene, 1-octyl-1,3-butadiene, and the like can be given.

As examples of a typical 2-alkyl-substituted 1,3-butadiene, 2-methyl-1,3-butadiene (isoprene), 2-ethyl-1,3-butadiene, 2-propyl-1,3-butadiene, 2-isopropyl-1,3-butadiene, 2-butyl-1,3-butadiene, 2-isobutyl-1,3-butadiene, 2-amyl-1,3-butadiene, 2-isoamyl-1,3-butadiene, 2-hexyl-1,3-butadiene, 2-cyclohexyl-1,3-butadiene, 2-isohexyl-1,3-butadiene, 2-heptyl-1,3-butadiene, 2-isoheptyl-1,3-butadiene, 2-octyl-1,3-butadiene, 2-isooctyl-1,3-butadiene, and the like can be given. Among these conjugated dienes, isoprene and 1,3-pentadiene can be given as preferable conjugated dienes to be copolymerized with butadiene. The butadiene content of monomer components to be polymerized is preferably 50 mol % or more, and particularly preferably 70 mol % or more.

The syndiotactic 1,2-polybutadiene used in the present invention can be obtained by polymerizing butadiene in the presence of a catalyst containing a cobalt compound and aluminoxane, for example, as described above. As the cobalt compound, a salt of an organic acid preferably having 4 or more carbon atoms and cobalt can be given. As specific examples of the organic acid salt, butyrate, hexanoate, heptylate, octylate such as 2-ethylhexylate, decanoate, salts of higher fatty acid such as stearic acid, oleic acid, and erucic acid, benzoate, tolylate, xylylate, alkyl-substituted, aralkyl-substituted, or aryl-substituted benzoates such as ethyl benzoate, naphthoate, and alkyl-substituted, aralkyl-substituted, or aryl-substituted naphthoates can be given. Of these, octylate such as 2-ethylhexylate, stearate, and benzoate are preferable due to excellent solubility in hydrocarbon solvents.

As the above-mentioned aluminoxane, aluminoxanes represented by the following formulas (I) and (II), for example, can be mentioned.

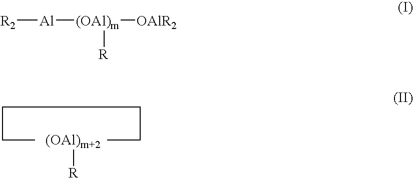

In aluminoxanes represented by the formulas (I) and (II), R is a hydrocarbon group such as a methyl group, ethyl group, propyl group, and butyl group, preferably a methyl group and ethyl group, and particularly preferably a methyl group. m is an integer of 2 or more, preferably 5 or more, and still more preferably 10 to 100. As the specific examples of aluminoxane, methylaluminoxane, ethylaluminoxane, propylaluminoxane, butylaluminoxane, and the like can be given. Of these, methylaluminoxane is particularly preferable.

It is extremely preferable for the polymerization catalyst to contain a phosphine compound in addition to the cobalt compound and aluminoxane. The phosphine compound is effective for activating the polymerization catalyst and controlling the vinyl bond structure and crystallinity. As a preferable phosphine compound, an organic phosphorus compound shown by the following formula (III) can be given.
P—(Ar)ₙ—(R′)₃₋ₙ (III)
wherein R′ represents a cycloalkyl group or an alkyl-substituted cycloalkyl group, n is an integer of 0 to 3, and Ar represents a group shown by the following formula, 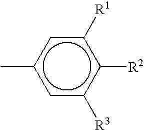
wherein R¹, R², and R³, which may be either the same or different, represent a hydrogen atom, an alkyl group having preferably 1 to 6 carbon atoms, a halogen atom, an alkoxy group having preferably 1 to 6 carbon atoms, or an aryl group having preferably 6 to 12 carbon atoms. As specific examples of the phosphine compound represented by the formula (III), tris(3-methylphenyl)phosphine, tris(3-ethylphenyl)phosphine, tris(3,5-dimethylphenyl)phosphine, tris(3,4-dimethylphenyl)phosphine, tris(3-isopropylphenyl)phosphine, tris(3-t-butylphenyl)phosphine, tris(3,5-diethylphenyl)phosphine, tris(3-methyl-5-ethylphenyl)phosphine, tris(3-phenylphenyl)phosphine, tris(3,4,5-trimethylphenyl)phosphine, tris(4-methoxy-3,5-dimethylphenyl)phosphine, tris(4-ethoxy-3,5-diethylphenyl)phosphine, tris(4-butoxy-3,5-dibutylphenyl)phosphine, tris(p-methoxyphenyl)phosphine, tricyclohexylphosphine, dicyclohexylphenylphosphine, tribenzylphosphine, tris(4-methylphenyl)phosphine, tris(4-ethylphenyl)phosphine, and the like can be given. Of these, triphenylphosphine, tris(3-methylphenyl)phosphine, tris(4-methoxy-3,5-dimethylphenyl)phosphine, and the like are particularly preferable.

As the cobalt compound, a compound of the following formula (IV) can be used.

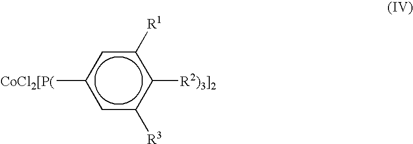

The compound of the formula (IV) is a complex of cobalt chloride with a phosphine compound having n=3 in the above formula (III) as a ligand. In the polymerization, either a method of using a previously synthesized cobalt compound of the formula (IV) or a method of causing cobalt chloride to come in contact with the phosphine compound in the polymerization system may be employed. The 1,2-bond content and the degree of crystallinity of the resulting syndiotactic 1,2-polybutadiene can be controlled by appropriately selecting the type of phosphine compound in the complex.

As specific examples of the cobalt compound represented by the formula (IV), cobalt bis(triphenylphosphine) dichloride, cobalt bis[tris(3-methylphenyl)phosphine]dichloride, cobalt bis[tris(3-ethylphenyl)phosphine]dichloride, cobalt bis[tris(4-methylphenyl)phosphine]dichloride, cobalt bis[tris(3,5-dimethylphenyl)phosphine]dichloride, cobalt bis[tris(3,4-dimethylphenyl)phosphine]dichloride, cobalt bis[tris(3-isopropylphenyl)phosphine]dichloride, cobalt bis[tris(3-t-butylphenyl)phosphine]dichloride, cobalt bis[tris(3,5-diethylphenyl)phosphine]dichloride, cobalt bis[tris(3-methyl-5-ethylphenyl)phosphine]dichloride, cobalt bis[tris(3-phenylphenyl)phosphine]dichloride, cobalt bis[tris(3,4,5-trimethylphenyl)phosphine]dichloride, cobalt bis[tris(4-methoxyl-3,5-dimethylphenyl)phosphine]dichloride, cobalt bis[tris(4-ethoxyl-3,5-diethylphenyl)phosphine]dichloride, cobalt bis[tris(4-butoxy-3,5-dibutylphenyl)phosphine]dichloride, cobalt bis[tris(4-methoxyphenyl)phosphine]dichloride, cobalt bis[tris(3-methoxyphenyl)phosphine]dichloride, cobalt bis[tris(4-dodecylphenyl)phosphine]dichloride, cobalt bis[tris(4-ethylphenyl)phosphine]dichloride, and the like can be given.

Among these, cobalt bis(triphenylphosphine) dichloride, cobalt bis[tris(3-methylphenyl)phosphine]dichloride, cobalt bis[tris(3,5-dimethylphenyl)phosphine]dichloride, cobalt bis[tris(4-methoxy-3,5-dimethylphenyl)phosphine]dichloride, and the like are particularly preferable.

The amount of the cobalt compound in the catalyst used in the polymerization of butadiene or copolymerization of butadiene and other conjugated dienes, in terms of the amount of cobalt atom per one mol of butadiene (in the case of homopolymerization) or the total of butadiene and the other conjugated dienes (in the case of copolymerization), is about 0.001 to 1 mmol, and preferably 0.01 to 0.5 mmol. The amount of the phosphine compound, in terms of the ratio of phosphorus atom to cobalt atom (P/Co), is usually 0.1 to 50, preferably 0.5 to 20, and more preferably 1 to 20. The amount of aluminoxane, in terms of the ratio of aluminum atom to cobalt atom (Al/Co), is usually 4 to 10⁷, and preferably 10 to 10⁶. When the complex compound of the formula (IV) is used, the amount of the phosphine compound, in terms of the ratio of phosphorus atom to cobalt atom (P/Co), is 2, and the aluminoxane is used in an amount described above.

As the inert organic solvent used as a polymerization solvent, aromatic hydrocarbon solvents such as benzene, toluene, xylene, and cumene, aliphatic hydrocarbon solvents such as n-pentane, n-hexane, and n-butane, alicyclic hydrocarbon solvents such as cyclopentane, methylcyclopentane, and cyclohexane, and mixtures of these solvents can be given.

The polymerization temperature is usually −50 to 120° C., and preferably −20 to 100° C.

Either a batch polymerization system or a continuous polymerization system may be used for the polymerization reaction. The monomer concentration in the solvent is usually 5 to 50 wt %, and preferably 10 to 35 wt %.

In order to produce polymers without deactivating the catalyst and polymer of the present invention, strict care must be taken to minimize inclusion of compounds that deactivate the catalyst and polymer, such as oxygen, water, or carbon dioxide gas, in the polymerization system. When the polymerization reaction has proceeded to a desired stage, alcohol and other additives such as a polymerization terminator, antiaging agent, antioxidant, UV absorber, and the like are added, and the produced polymer is separated, washed, and dried according to a conventional method to obtain syndiotactic 1,2-polybutadiene used in the present invention.

The weight average molecular weight of the syndiotactic 1,2-polybutadiene used in the present invention is preferably 10,000 to 5,000,000, more preferably 10,000 to 1,500,000, and particularly preferably 50,000 to 1,000,000. If the weight average molecular weight is less than 10,000, the polymer exhibits extremely high fluidity, is very difficult to be processed, and produces sticky molded products (medical components). If the weight average molecular weight is more than 5,000,000, on the other hand, the polymer exhibits extremely low fluidity and is very difficult to be processed.

As specific examples of the syndiotactic 1,2-polybutadiene used in the present invention, “RB810” (1,2-bond content: 90%, melt flow rate (150° C., 2.16 kg): 3 g/10 min, degree of crystallinity: 18%), “RB820” (1,2-bond content: 92%, melt flow rate (150° C., 2.16 kg): 3 g/10 min, degree of crystallinity: 25%), “RB830” (1,2-bond content: 93%, melt flow rate (150° C., 2.16 kg): 3 g/10 min, degree of crystallinity: 29%), and “RB840” (1,2-bond content: 90%, melt flow rate (150° C., 2.16 kg): 8 g/10 min, degree of crystallinity: 35%), manufactured by JSR Corp., and the like can be given.

As specific examples of thermoplastic elastomers other than syndiotactic 1,2-polybutadiene, at least one selected from the group consisting of styrene-isoprene-styrene block copolymer (SIS), styrene-butadiene-styrene block copolymer (SBS), hydrogenated products of these copolymers (SEPS, SEBS), polyisoprene, ethylene-propylene copolymer (EPM), ethylene-octene copolymer (EOM), various polyethylenes (LLDPE, ULDPE, LDPE), ethylene-vinyl acetate copolymer, and the like can be given, with styrene-isoprene-styrene block copolymer (SIS) being preferable.

As specific examples of the styrene-isoprene-styrene block copolymer (SIS), “SIS5229P” (styrene content: 15 wt %, melt flow rate (190° C., 2.16 kg): 3 g/10 min) and “SIS5002” (styrene content: 22 wt %, melt flow rate (190° C., 2.16 kg): 2 g/10 min), manufactured by JSR Corp., and the like can be given.

As specific examples of the styrene-butadiene-styrene block copolymer (SBS), “TR2003” (styrene content: 43 wt %, melt flow rate (190° C., 2.16 kg): 5 g/10 min) and “TR2827” (styrene content: 24 wt %, melt flow rate (190° C., 2.16 kg): 2 g/10 min), manufactured by JSR Corp., and the like can be given.

As specific examples of the hydrogenated products of the styrene-isoprene-styrene block copolymer (SIS) or the styrene-butadiene-styrene block copolymer (SBS), i.e. SEPS or SEBS, “SEPS Septon 2043” (styrene content: 13 wt %, melt flow rate (230° C., 2.16 kg): 4 g/10 min) manufactured by Kuraray Co. Ltd. and “SEBS Kraton G1657” (styrene content: 13 wt %, melt flow rate (200° C., 5 kg): 8 g/10 min), manufactured by Kraton, and the like can be given.

As specific examples of the polyisoprene, “R2200” (cis 1,4-polyisoprene content: 98 wt %), manufactured by JSR Corp., and the like can be given.

As specific examples of the ethylene-propylene copolymer (EPM), “EP01P” (propylene content: 22 wt %, melt flow rate (230° C., 2.16 kg): 4 g/10 min) and “EP07P” (propylene content: 27 wt %, melt flow rate (230° C., 2.16 kg): 1 g/10 min), manufactured by JSR Corp., and the like can be given.

As specific examples of the ethylene-octene copolymer (EOM), “ENGAGE8550” (density: 0.902) manufactured DuPont Dow Elastomers Co., and the like can be given.

As specific examples of the various polyethylenes (LLDPE, ULDPE, LDPE), “YF30” (LDPE, melt flow rate (190° C., 2.16 kg): 1 g/10 min) and “UF240” (LLDPE, melt flow rate (190° C., 2.16 kg): 2 g/10 min), manufactured by Japan Polyethylene Corp., and the like can be given.

As specific examples of the ethylene-vinyl acetate copolymer, “LV440” (vinyl acetate content: 15 wt %, melt flow rate (190° C., 2.16 kg): 2 g/10 min), manufactured by Japan Polyethylene Corp., and the like can be given.

As required, in addition to the above thermoplastic elastomer components, the composition used in the present invention may contain additives such as a lubricant, filler, antiaging agent, and the like. Given as specific examples of the additives are lubricants such as paraffin oil, silicone oil, liquid polyisoprene, liquid polybutadiene, erucic acid amide, stearic acid amide, and low molecular polyethylene; fillers such as talc, silica, magnesium hydroxide, calcium carbonate, glass, carbon fiber, and glass balloon; and antiaging agents such as a phenol type antiaging agent and a phosphorus type antiaging agent.

The lubricant is added in an amount of 5 parts by weight or less, preferably 0.01 to 2 parts by weight, for 100 parts by weight of the total amount of the thermoplastic elastomer components. An amount of more than 5 parts by weight is undesirable because the lubricant may bleed out from the product and be transferred to a medical fluid.

In addition, in order to increase the balance between heat resistance by irradiation with electron beams and flexibility, other additives, for example, a polyfunctional monomer such as trimethylpropane trimethacrylate, a photoinitiator such as hydroxycyclohexyl phenyl ketone, a photosensitizer such as benzophenone, and the like may be added in an amount of 5 parts by weight or less for 100 parts by weight of the syndiotactic 1,2-polybutadiene.

<Preparation of Composition and Molding>

The thermoplastic elastomer molded article of the present invention can be obtained by softening with heating and kneading the 1,2-polybutadiene alone or the 1,2-polybutadiene and the other thermoplactic elastomers, optionally adding the above additives and the like.

Kneading and molding are carried out at a temperature equal to or higher than the softening point or melting point of the syndiotactic 1,2-polybutadiene, at which the thermoplastic elastomer composition can be excellently molded, to obtain a uniform molded article (medical components such as a tube). For this reason, the molding temperature is preferably about 90 to 170° C. In order to obtain molded articles such as a tube, sheet, and hose, molding methods such as press molding, extrusion molding, injection molding, blow molding, contour extrusion molding, T-die film molding, inflation molding, powder slash molding, rotational molding, and the like are used.

<Electron Beam Irradiation>

Because a tube requires flexibility among the thermoplastic elastomer molded articles of the present invention such as a polybutadiene molded article (hereinafter referred to from time to time as “thermoplastic elastomer molded article”), a low crystalline RB is preferably used. Since the low crystalline RB has a low melting point, the molded article can be irradiated with electron beams for cross-linking in order to provide steam sterilization resistance. Irradiation with electron beams produces syndiotactic 1,2-polybutadiene with a three-dimensional crosslinking structure by radical polymerization of vinyl groups, resulting in improved heat resistance of the molded articles (tubes). Electron beams are penetrable through a synthetic resin and the degree of penetration depends on the thickness of molded articles and energy of electron beams.

A molded article (tube) with a uniform degree of cross-linking in the thickness direction can be obtained by controlling the energy of electron beams so that the electron beams may uniformly penetrate in the thickness direction according to the irradiation thickness.

Electron beam energy applied to the thermoplastic elastomer molded articles such as a tube (medical components such as a tube for medical use) is preferably 50 to 3,000 kV, and still more preferably 300 to 2,000 kV. If less than 50 kV, the relative amount of electrons captured and absorbed near the surface layer increases and the amount of electron beams penetrating the molded articles decreases, resulting in a retardation of cross-linking in the inner part as compared with the surface and in variations in the degree of cross-linking. If more than 3,000 kV, on the other hand, the degree of cross-linking is too great and the resulting molded articles exhibit high hardness and low elasticity and elongation.

The electron beams are irradiated in a dose of preferably 1 to 100 Mrad (corresponding to 10 to 1,000 kGy in SI units), and more preferably 1 to 50 Mrad, to cross-link the molded article for curing. If less than 1 Mrad, the degree of cross-linking of the 1,2-polybutadiene is too small. If more than 100 Mrad, the degree of cross-linking is too great and the resulting molded articles exhibit high hardness and low elasticity and elongation.

The degree of cross-linking by electron beam irradiation can be indicated by the product of the electron beam accelerating voltage and the irradiation dose. The product of the electron beam accelerating voltage (kV) and the irradiation dose (Mrad) is preferably 2,000 to 20,000 kV-Mrad, and more preferably 5,000 to 16,000 kV-Mrad. If less than 2,000 (kV-Mrad), the amount of electrons captured and absorbed near the surface layer comparatively increases and the amount of electron beams penetrating the thermoplastic elastomer molded articles (medical components) decreases, resulting in a retardation of cross-linking in the inner part as compared with the surface and in variations in the degree of cross-linking. If more than 20,000 kV-Mrad, the degree of cross-linking is too great and the resulting molded articles exhibit large hardness and small elasticity and elongation.

<Surface Treating of Thermoplastic Elastomer Molded Article>

In the present invention, the surface of a thermoplastic elastomer molded article is treated with a silicone emulsion and/or aqueous solution of silicone containing water-soluble silicone with a silicone content of 1 to 30 wt %. If the surface is treated with a silicone emulsion and/or aqueous solution of silicone in this manner, sliding properties and sliding wear resistance of the thermoplastic elastomer molded article can be improved, without impairing general properties of the thermoplastic elastomer molded article such as transparency, flexibility, lightweightness, and mechanical strength, because silicone coating is provided on the surface of the molded article.

Any silicone emulsion which is in a state of emulsion of a water-insoluble silicone resin dispersed in water and the like can be used for the above silicone emulsion. For example, the silicone emulsion described in [0017] of JP-A-2004-211060 can be given.

The silicone emulsion can be obtained by, for example, the following methods.

(1) A method of emulsifying an alkyl silicate compound or a partially hydrolysis-condensed product thereof using various types of surfactants to prepare an aqueous emulsion (JP-A-58-213046, JP-A-62-197369, JP-A-3-115485, and JP-A-3-200793) and a method of further mixing this emulsion with an emulsion produced by polymerizing a polymerizable vinyl monomer by emulsion polymerization (JP-A-6-344665).

(2) A method of polymerizing a radically polymerizable vinyl monomer by emulsion polymerization in the presence of a water-soluble polymer obtained by hydrolyzing an alkyl silicate compound in water without using surfactants (JP-A-8-60098).

(3) A method of hydrolyzing and condensing an alkyl silicate mixture containing a vinyl polymerizable alkyl silicate to produce an aqueous emulsion containing a solid silicone resin, adding a radically polymerizable vinyl monomer, and polymerizing the mixture by emulsion polymerization to obtain a graft copolymer fine particle (solid) emulsion (JP-A-5-209149 and JP-A-7-196750).

(4) A method of adding an alkyl silicate compound to an emulsion produced by polymerizing a radically polymerizable functional groups by emulsion polymerization to hydrolyze and condense the mixture to introduce a silicone resin into the emulsion particles (JP-A-3-45628 and JP-A-8-3409).

(5) A method of preparing an emulsion by polymerizing an alkyl silicate containing a vinyl-polymerizable functional group with a radically polymerizable vinyl monomer by emulsion polymerization (JP-A-61-9463 and JP-A-8-27347).

These silicone emulsions are aqueous emulsions having a solid component content (silicone content) of usually 10 to 70 wt %, and preferably 20 to 60 wt %.

These silicone emulsions can be used in the present invention usually in a state of an emulsion having a silicone content of 1 to 30 wt %, and preferably 2 to 10 wt %, obtained by diluting the silicone emulsion with water having a high degree of purity such as pure water, purified water, and ion-exchanged water. If the silicone content is less than 1 wt %, the static coefficient of friction decreases only to a small extent, resulting in only a small improvement effect of sliding properties and sliding wear resistance. On the other hand, the silicone content exceeding 30 wt % does not decrease the static coefficient of friction any more, bringing about only a cost increase, without any further improvement of sliding properties and sliding wear resistance.

There is no specific restriction to the water-soluble silicone used in the present invention as long as such a silicone is water-soluble. For example, those described in [0008] to [0012] of JP-A-2001-261961 can be given.

Specifically, as the water-soluble silicone, a polyoxyalkylene-modified silicone oil, aminoalkyl group-containing silicone oil, amide group-containing silicone oil, carbinol group-containing siloxane oligomer, and the like can be given, with the polyoxyalkylene-modified silicone oil being preferable.

Of these, as an example of polyoxyalkylene-modified silicone oil, an organopolysiloxane having a polyoxyaklylene group in the side chains or molecular terminals represented by the following average molecular formula can be given. 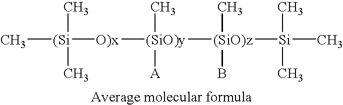
wherein x and y are individually an integer of 1 or more, z is 0 or an integer of 1 or more, A is an organic group represented by the formula —(CH₂)a-O—(C₂H₄O)p(C₃H₆O)qR, wherein a is an integer of 1 to 3, p is an integer of 1 or more, q is 0 or an integer of 1 or more, and R is a hydrogen atom or an alkyl group having 1 to 4 carbon atoms such as a methyl group, ethyl group, and propyl group, and B is an organic group represented by the formula —(CH₂)r-CH₃, wherein r is an integer of 0 or more. 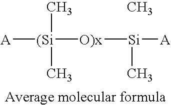
wherein x and A are the same as above. 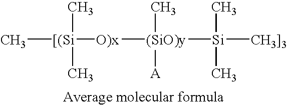
wherein x, y, and A are the same as above.

The polyoxyalkylene moiety of such a polyoxyalkylene-modified silicone oil is preferably polyoxyethylene or oxyethylene-oxypropylene copolymer and the content thereof in the molecule is preferably 50 wt % or more in order to obtain a good water-solubility of the polyoxyalkylene-modified silicone oil.

In order to prepare an aqueous solution of silicone using the above water-soluble silicone, water having a high degree of purity such as pure water, purified water, and ion-exchanged water is preferably used.

The silicone content of the aqueous solution of silicone is 1 to 30 wt %, and preferably 2 to 10 wt %. If the silicone content is less than 1 wt %, the static coefficient of friction decreases only to a small extent, resulting in only a small improvement effect of sliding properties and sliding wear resistance. On the other hand, the silicone 0 content exceeding 30 wt % does not decrease the static coefficient of friction any more, bringing about only a cost increase, without any further improvement of sliding properties and sliding wear resistance.

The surface treatment of the thermoplastic elastomer molded article can be conducted according to a common method using the above silicone emulsion and/or aqueous solution of silicone.

As the method for the surface treatment, dipping treatment, application treatment using a brush, a piece of cloth, and the like, spraying treatment using a spray and the like can be given. Of these, dipping treatment is preferable.

In the dipping treatment, the thermoplastic elastomer molded article such as a tube for medical use is dipped in a dipping bath containing a silicone emulsion and/or aqueous solution of silicone with a silicone content of 1 to 30 wt %. The temperature of the dipping bath is usually 10 to 30° C., and preferably normal temperature. When a molded article of tube is produced by contour extrusion, the surface of the molded article can be treated while cooling by continuously dipping the tube which is contour-extruded from a die in the dipping bath. Next, the thermoplastic elastomer molded article is removed from the dipping bath and dried at preferably 20 to 80° C., and more preferably 30 to 60° C., for preferably 10 to 480 min, and more preferably 20 to 240 min.

The amount of the silicone (coating) applied to the thermoplastic elastomer molded article is, in terms of a solid component amount, 0.1 g/m² to 8 g/m², preferably 0.2 g/m² to 4 g/m², and more preferably 0.4 g/m² to 2 g/m². If the amount is less than 0.1 g/m², the static coefficient of friction decreases only to a small extent, resulting in only a small improvement effect of sliding properties and sliding wear resistance. On the other hand, the amount exceeding 8 g/m² does not decrease the static coefficient of friction any more, bringing about only a cost increase, without any further improvement of sliding properties and sliding wear resistance. The amount of the silicone applied can be controlled by the silicone concentration.

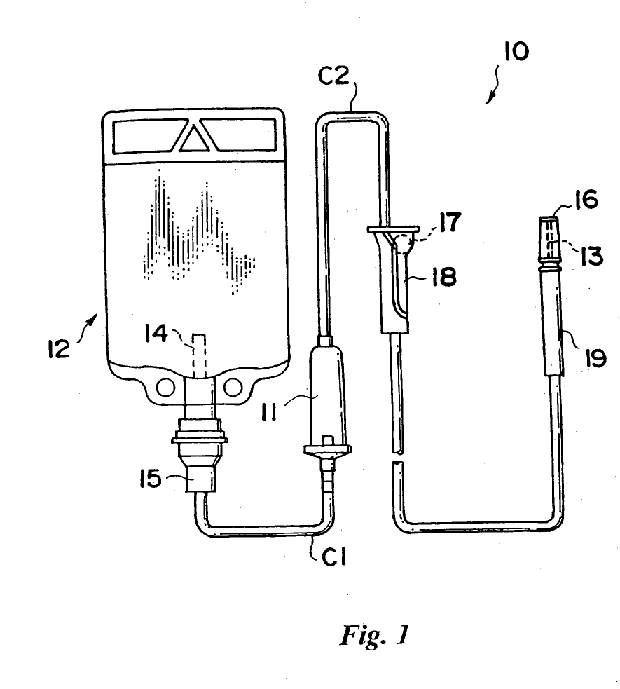

Next, a specific embodiment of an infusion set using the tube for medical use, which is the thermoplastic elastomer molded article of the present invention, will be described in detail referring to FIG. 1.

The infusion set 10 is provided with a connecting member (connector) 15 for connecting an infusion discharge tube 14 in an infusion bag 12, a first tube C1 for connecting the connecting member 15 with a dripping cylinder 11, a second tube C2 for connecting the dripping cylinder 11 and a puncture needle 13, a clamp 18 for adjusting the transfusion rate, and a cap 16 for covering the puncture needle 13. The component indicated by 19 is a connecting member for connecting the second tube C2 and the puncture needle 13.

As the puncture needle 13, a metal needle made from hollow stainless steel and the like or a synthetic resin needle having a blade edge for puncture at the tip can be used. A roller clamp is used as the clamp 18. This roller clamp is equipped with a roller 17 which is installed movably and narrows the fluid passage of the second tube C2 when moved to the side of the puncture needle 13, thereby controlling the transfusion rate. The dripping cylinder 11 is provided with a filter (not shown) in case foreign matter should be included in the transfusion materials and the like. A conventional puncture needle is used as the puncture needle 13.

The connecting member 15, dripping cylinder 11, and connecting member 19 are all connectors having a tube joining part and are made from a hard resin such as polycarbonate, polyester, transparent ABS, or vinyl chloride resin.

As a material for the tubes C1 and C2, transparent soft tube is preferable. For example, a conventional tube made from soft vinyl chloride resin or a tube made from the syndiotactic 1,2-polybutadiene of the present invention, i.e. syndiotactic 1,2-polybutadiene with a low degree of crystallinity of about 5% or more, preferably about 5 to 25%, of which the surface is treated with a silicone emulsion and/or aqueous solution of silicone containing a water-soluble silicone, can be used.

The ends of the tubes C1 and C2 are firmly secured with the tube joining part of the connecting member 15, dripping cylinder 11, and connecting member 19 (all of them are corresponding to connectors in the present invention) by solvent adhesion, adhesion using an adhesive, supersonic adhesion, or high frequency adhesion.

Examples of the solvent for the solvent adhesion used here include tetrahydrofuran, cyclohexane, cyclohexanone, methyl ethyl ketone, acetone, ethyl acetate, toluene, and the like as described above.

Since a tube having a surface treated with the silicone emulsion and/or aqueous solution of silicone is used in the infusion set, it is preferable that the silicone component on the adhesion surface is washed off with water or the inner surface of the tube is used as the adhesion surface.

In the present invention, a medical component consisting of a tube and a connector having a tube joining part can also be applied to a component of the infusion set or a component of medical apparatus such as a catheter for medical fluid infusion.

### EXAMPLES

The present invention will be described in more detail by way of examples, which should not be construed as limiting the present invention. In the examples below “parts” and “%” indicate “parts by weight” and “% by weight”, respectively, unless otherwise specified. Preparation of test specimens (plates and tubes) and measurements in the examples were conducted as follows.

(Preparation of Test Specimens)

1,2-polybutadiene (“RB820” manufactured by JSR Corp.) was molded into the shape of a plate with a thickness of 2 mm by an injection molder at a temperature of 120 to 140° C. In addition, the 1,2-polybutadiene was molded into the shape of a tube with an inner diameter of 3 mm, outer diameter of 4.4 mm, and thickness of 0.7 mm using a contour extruder (L/D=28) at a temperature of 120 to 140° C.

When a silicone oil was added to 1,2-polybutadiene (“RB820” manufactured by JSR Corp.), the 1,2-polybutadiene, which was previously kneaded using a single axis extruder (L/D=32) at a temperature of 120 to 140° C., was molded into the shape of a plate with a thickness of 2 mm by an injection molder at a temperature of 120 to 140° C. In addition, the 1,2-polybutadiene was molded into the shape of a tube with an inner diameter of 3 mm, outer diameter of 4.4 mm, and thickness of 0.7 mm using a contour extruder (L/D=28) at a temperature of 120 to 140° C.

When a silicone oil was added to 1,2-polybutadiene (“RB820” manufactured by JSR Corp.) and a styrene-isoprene-styrene block copolymer (“SIS5229P” manufactured by JSR Corp.), the composition, which was previously kneaded using a single axis extruder (L/D=32) at a temperature of 120 to 170° C., was molded into the shape of a plate with a thickness of 2 mm by an injection molder at a temperature of 120 to 170° C. In addition, the composition was molded into the shape of a tube with an inner diameter of 3 mm, outer diameter of 4.4 mm, and thickness of 0.7 mm using a contour extruder (L/D=28) at a temperature of 120 to 170° C.

For surface treatment, the entire plate or tube was dipped in 300 cc of a silicone-containing liquid for two seconds, removed from the liquid, and dried in a thermostatic bath at 50° C. for three hours.

(Silicone Adhesion Amount)

Ten sheets of plate (size: 50 mm×50 mm×2 mm) were completely dipped one after another in 300 cc of a silicone-containing liquid, of which the weight was previously measured, for two seconds. After dipping, the weight of the silicone-containing liquid was again measured to determine the weight of the silicone-containing liquid consumed. The amount of silicone adhered per unit surface area was calculated from the surface area of the ten plates and the silicone concentration.

(Static Coefficient of Friction)

The static coefficient of friction was measured using the plate and a measuring instrument for coefficient of friction of film (“AFT-15-1” manufactured by Tosoku Seimitsu Kogyo Co.).

(Scratching of Tube by Pump)

A tube was installed on a pump (“OT-711” manufactured by JMS Co., Ltd.) and used at a transfusion rate of 500 ml/hr for 15 hours to evaluate the degree of scratching by visual observation.
Good: Almost no traces of cuts nor ground material powder adhering to the tube surface were observed on the tube surface.
Bad: Many traces of cuts and a significant amount of ground material powder adhering were observed on the tube surface.
   (Haze Value)

Haze value is a measure for indicating transparency. The smaller the haze value, the better the transparency. The haze value was measured using the plate according to ASTMD-1003.

(Tackiness)

The surfaces of the plate and tube were evaluated by finger contact.

Good: The surface was smooth and not tacky.

Bad: The surface was greasy and tacky.

(Work Environment)

Good: No solvent odor was sensed by the nose close to the bath containing 300 cc of the silicone-containing liquid during the surface treatment.
Fair: A solvent odor was sensed by the nose close to the bath containing 300 cc of the silicone-containing liquid during the surface treating.
Bad: A solvent odor was sensed at a point 2 m away from the bath containing 300 cc of the silicone-containing liquid during the surface treating.
   (Density)

The density was measured using the plate according to JISK 7112.

(Hardness)

The hardness was measured using the plate according to JISK 6253.

(Tensile Test: Break Strength)

The tensile test was conducted using the plate according to JISK 6251.

### Example 1

The results of evaluation of plates and a tube made from 1,2-polybutadiene (“RB820” manufactured by JSR Corp.), of which the surfaces were treated with an emulsion with a silicone content of 2%, are shown in Table 1.

### Examples 2 to 8 and Comparative Examples 1 to 8

The results of evaluation of plates and tubes made from 1,2-polybutadiene (“RB820” manufactured by JSR Corp.), a composition of “RB820” and styrene-isoprene-styrene block copolymer (“SIS5229P” manufactured by JSR Corp.), a composition of “RB820” and a silicone oil, and a composition of “RB820”, “SIS5229P”, and a silicone oil, with the surfaces untreated or treated as described in Example 1, are shown in Tables 1 and 2.

It is confirmed that the products of Examples 1 to 8 excel in work environment preservation, have a small static coefficient of friction, small scratching resistance by pump, and no tackiness, are transparent, and possess other original properties inherent to a molded article of 1,2-butadiene (and a blend of this and a SIS block copolymer) such as a density, hardness, and break strength.

On the other hand, the products of Comparative Examples 1 and 2, which were not surface-treated, had a large static coefficient of friction and exhibited poor scratching resistance by pump. Comparative Examples 3 and 4, in which a silicone oil was blended in the molded articles, exhibited a large static coefficient of friction and poor transparency. Comparative Examples 5 and 7, in which the molded articles were surface-treated with a silicone oil, exhibited poor silicone oil applicability and tackiness due to a high viscosity of silicone oil. Comparative Examples 6 and 8, in which the molded articles were surface-treated with a toluene solution of silicone, exhibited a poor transparency and impaired work environment (solvent dispersal).

TABLE 1

| | Example | | | | | | | |
|---|---|---|---|---|---|---|---|---|
| | 1 | 2 | 3 | 4 | 5 | 6 | 7 | 8 |
| (Composition) | | | | | | | | |
| RB820 *1 | 100 | 100 | 100 | 100 | 80 | 80 | 80 | 80 |
| SIS5229P *2 | | | | | 20 | 20 | 20 | 20 |
| (Surface treating) | | | | | | | | |
| Emulsion with silicone content of 2% *4 | Treated | | | | Treated | | | |
| Emulsion with silicone content of 9% *4 | | Treated | | | | Treated | | |
| Solution with silicone content of 2% *5 | | | Treated | | | | Treated | |
| Solution with silicone content of 9% *5 | | | | Treated | | | | Treated |
| Silicone adhesion amount (g/m²) | 0.6 | 1.2 | 0.5 | 1.1 | 0.7 | 1.3 | 0.6 | 1.2 |
| (Properties) | | | | | | | | |
| Static coefficient of friction (μ) | 0.9 | 0.5 | 1 | 0.6 | 1.1 | 0.7 | 1.2 | 0.8 |
| Scratching of tube by pump | Good | Good | Good | Good | Good | Good | Good | Good |
| Haze value (%) | 8 | 9 | 8 | 9 | 26 | 27 | 26 | 27 |
| Tackiness | Good | Good | Good | Good | Good | Good | Good | Good |
| Work environment (solvent dispersal) | Good | Good | Good | Good | Good | Good | Good | Good |
| Density | 0.91 | 0.91 | 0.91 | 0.91 | 0.92 | 0.92 | 0.92 | 0.92 |
| Hardness (JIS-A) | 91 | 91 | 91 | 91 | 84 | 84 | 84 | 84 |
| Break strength (MPa) | 11 | 11 | 11 | 11 | 10 | 10 | 10 | 10 |

TABLE 2

| | Comparative Example | | | | | | | |
|---|---|---|---|---|---|---|---|---|
| | 1 | 2 | 3 | 4 | 5 | 6 | 7 | 8 |
| (Composition) | | | | | | | | |
| RB820 *1 | 100 | 80 | 100 | 80 | 100 | 100 | 80 | 80 |
| SIS5229P *2 | | 20 | | 20 | | | 20 | 20 |
| Silicone oil *3 | | | 1 | 1 | | | | |
| (Surface treating) | | | | | | | | |
| Silicone oil *3 | | | | | Treated | | Treated | |
| Toluene solution with silicone content of 5% *6 | | | | | | Treated | | Treated |
| Silicone adhesion amount (g/m²) | — | — | — | — | 29 | 0.9 | 32 | 1.0 |
| (Properties) | | | | | | | | |
| Static coefficient of friction (μ) | 2.5 | 2.8 | 1.9 | 2.2 | 1.5 | 0.8 | 1.2 | 0.8 |
| Scratching of tube by pump | Bad | Bad | Good | Good | Good | Good | Good | Good |
| Haze value (%) | 8 | 26 | 22 | 48 | 14 | 16 | 31 | 34 |
| Tackiness | Good | Good | Good | Good | Bad | Good | Bad | Good |
| Work environment (solvent dispersal) | — | — | — | — | Good | Bad | Good | Bad |
| Density | 0.91 | 0.92 | 0.91 | 0.92 | 0.91 | 0.91 | 0.92 | 0.92 |
| Hardness (JIS-A) | 91 | 84 | 90 | 84 | 91 | 91 | 84 | 84 |
| Break strength (MPa) | 11 | 10 | 10 | 9 | 11 | 11 | 10 | 10 |

*1: “RB820” (syndiotactic 1,2-polybutadiene, 1,2-vinyl bond content: 92%, degree of crystallinity: 25%, manufactured by JSR Corp.)
*2: “SIS5229P” (styrene-isoprene-styrene block copolymer, manufactured by JSR Corp.)
*3: “SH200” (silicone oil, manufactured by Shin-Etsu Chemical Industry Co., Ltd.)
*4: Emulsion of “KM742” (silicone emulsion, silicone content: 28%, manufactured by Shin-Etsu Chemical Industry Co., Ltd.), the silicone concentration of which was adjusted by diluting with water.
*5: Aqueous solution of “KM244F” (water-soluble silicone, silicone content: 100%, manufactured by Shin-Etsu Chemical Industry Co., Ltd.), the silicone concentration of which was adjusted by diluting with water.
*6: Solution of “KS725” (solution type silicone, solvent: petroleum hydrocarbon, silicone content: 50%, manufactured by Shin-Etsu Chemical Industry Co., Ltd.), the silicone concentration of which was adjusted by diluting with toluene.

By using the method of the present invention, in which the surface of a molded article made from a thermoplastic elastomer composition is simply treated using a silicone emulsion and/or aqueous solution of silicone containing a water-soluble silicone with a silicone content of 1 to 30 wt %, a thermoplastic elastomer molded article having a surface with improved sliding properties and sliding wear resistance and being produced in a good work environment, without unduly impairing original general properties of the thermoplastic elastomer such as transparency, flexibility, lightweight, and mechanical strength, can be obtained. The present invention can also be applied to various types of tubes, sheets, and hoses as well as molded articles such as a tube for medical use.

Whet is claimed is:

1. A thermoplastic elastomer molded article having a surface treated with a silicone emulsion and/or aqueous solution of silicone containing water soluble silicone with a silicone content of 1 to 30 wt %.

2. The thermoplastic elastomer molded article according to claim 1, wherein the thermoplastic elastomer which forms the molded article is a composition comprising 20 to 100 wt % of 1,2-polybutadiene having a 1,2-bond content of 70% or more and a degree of crystallinity of 5 to 50% and 0 to 80 wt % of other thermoplastic elastomers, provided that the total amount of 1,2-polybutadiene and the other thermoplactic elastomers is 100 wt %.

3. The thermoplastic elastomer molded article according to claim 2, wherein the other thermoplastic elastomer is a styrene-isoprene-styrene block copolymer.

4. A method for treating a surface of a thermoplastic elastomer molded article comprising dipping a molded article produced by contour extrusion in a silicone emulsion and/or aqueous solution of silicone containing water-soluble silicone with a silicone content of 1 to 30 wt %.

5. The thermoplastic elastomer molded article according to any one of claims 1 to 3, wherein the thermoplastic elastomer molded article is a tube for medical use.

6. An infusion set comprising the tube for medical use according to claim 5.
